(19) United States
(12) Patent Application Publication
(10) Pub. No.: US 2015/0190952 A1
(43) Pub. Date: Jul. 9, 2015

(54) FORMING METHOD OF A PATTERN OF A FOAM MAT

(71) Applicant: CHI-CHEN KAO, NANTOU COUNTY (TW)

(72) Inventor: HUI-LI WANG, TAICHUNG CITY (TW)

(73) Assignee: CHI-CHEN KAO, NANTOU COUNTY (TW)

(21) Appl. No.: 14/146,801

(22) Filed: Jan. 3, 2014

(51) Int. Cl. B29C 44/12

(52) U.S. Cl. CPC B29C 44/1285; B29K 2105/256

(57) ABSTRACT

A forming method of a pattern of a foam mat includes:
First step: a certain amount of foam plates being stacked up, so as to be defined as a form body, the form body having a bottom layer and a pattern layer, the bottom layer composed of some foam plates, the pattern layer overlaying a top side of the bottom layer, the pattern layer composed of a plurality of first patterning blocks, a shape of each first patterning block being pre-defined; a color of each first patterning block being different from a color of the bottom layer; and
Second step: the form body placed in a foaming mold so as to be heated and foamed; wherein, the first patterning blocks of the pattern layer integrated into the top side of the bottom layer during being heated and foamed, so that a foam mat body with a pattern is foamily molded.

### BACKGROUND OF THE INVENTION

1. Field of the Invention

The present invention relates to a forming method, and more particularly to a forming method of a pattern of a foam mat.

2. Description of the Prior Art

A conventional forming method of a pattern of a foam mat comprises the following steps.

First, a foaming material, a foaming agent and a crosslinking agent is mixed so as to be formed as a foam body.

Second, the form body is placed in a foaming mold so as to be heated and foamed.

Third, the form body is taken out from the foaming mold; then, the form body is cooled until being solidified.

Fourth, the solidified form body is cut into a plurality of foam mat bodies.

Fifth, each foam mat body is patterned via printing.

However, the conventional forming method of a pattern of a foam mat has some disadvantages as following:

First, the conventional forming method is complicated, because the conventional forming method need a further step to pattern the foam mat body.

Second, the pattern would unexpectedly peel off, because each foam mat body is patterned via printing.

Third, a surface of each foam mat body with the pattern is rough, because each foam mat body is patterned via printing. Therefore, the surface of each foam mat body is easy to smudge.

The present invention is, therefore, arisen to obviate or at least mitigate the above mentioned disadvantages.

### SUMMARY OF THE INVENTION

An object of the present invention is to provide a forming method.

To achieve the above and other objects, a forming method of a pattern of a foam mat comprises:

First step: a certain amount of foam plates being stacked up, so as to be defined as a form body, the form body having a bottom layer and a pattern layer, the bottom layer composed of some foam plates, the pattern layer overlaying a top side of the bottom layer, the pattern layer composed of a plurality of first patterning blocks, a shape of each first patterning block being pre-defined; a color of each first patterning block being different from a color of the bottom layer; and

Second step: the form body placed in a foaming mold so as to be heated and foamed; wherein, the first patterning blocks of the pattern layer integrated into the top side of the bottom layer during being heated and foamed, so that a foam mat body with a pattern is foamily molded.

Wherein, each second patterning block is located between each two adjacent first patterning blocks; the pattern layer further has a positioning plate; a shape of the positioning plate is the same as a shape of the bottom layer; the positioning plate has a plurality of positioning openings formed thereon; each positioning opening corresponds to each corresponding first patterning block; each first patterning block is inserted into each corresponding positioning opening; the pattern layer further has a positioning plate; a shape of the positioning plate is the same as a shape of the bottom layer; the first patterning blocks are varicolored; the first patterning blocks are grouped into some groups according to the pattern type of the foam mat; the positioning plate has a plurality of positioning openings formed thereon; each positioning opening corresponds to each corresponding group of the first patterning blocks; each group of the first patterning blocks is inserted into each corresponding positioning opening; the forming method of a pattern of a foam mat further comprises:

Third step: the foam mat body taken out from the foaming mold, the foam mat body cut into a plurality of foam mat pieces; wherein, a plurality of interlocking teeth is defined at each peripheral side of each foam mat piece.

A forming method of a pattern of a foam mat comprises:

First step: a certain amount of foam plates being stacked up, so as to be defined as a form body, the form body having a bottom layer, a pattern layer and a covering layer, the bottom layer composed of some foam plates, the pattern layer overlaying a top side of the bottom layer, the covering layer overlaying a top side of the pattern layer, the pattern layer composed of a plurality of first patterning blocks; a shape of each first patterning block being pre-defined, a color of each first patterning block being different from a color of the bottom layer;

Second step: the form body placed in a foaming mold so as to be heated and foamed; wherein, the first patterning blocks of the pattern layer are integrated into the bottom layer and the covering layer during being heated and foamed, so that a semi-finished body is foamily molded; and

Third step: the semi-finished body taken out from the foaming mold, the covering layer cut from the pattern layer, so as to define a foam mat body with a pattern.

Wherein, each second patterning block is located between each two adjacent first patterning blocks; the pattern layer further has a positioning plate; a shape of the positioning plate is the same as a shape of the bottom layer; the positioning plate has a plurality of positioning openings formed thereon; each positioning opening corresponds to each corresponding first patterning block; each first patterning block is inserted into each corresponding positioning opening; the pattern layer further has a positioning plate; a shape of the positioning plate is the same as a shape of the bottom layer; the first patterning blocks are varicolored; the first patterning blocks are grouped into some groups according to the pattern type of the foam mat; the positioning plate has a plurality of positioning openings formed thereon; each positioning opening corresponds to each corresponding group of the first patterning blocks; each group of the first patterning blocks is inserted into each corresponding positioning opening; the forming method of a pattern of a foam mat further comprises:

Fourth step: the foam mat body taken out from the foaming mold, the foam mat body cut into a plurality of foam mat pieces; wherein, a plurality of interlocking teeth is defined at each peripheral side of each foam mat piece.

A forming method of a pattern of a foam mat comprises:

First step: a certain amount of foam plates being stacked up, so as to be defined as a form body, the form body having a bottom layer and a pattern layer, the bottom layer composed of some foam plates, the pattern layer mounted between two foam plates of the bottom layer, the pattern layer composed of a plurality of first patterning blocks, a shape of each first patterning block being pre-defined, a color of each first patterning block being different from a color of the bottom layer;

Second step: the form body placed in a foaming mold so as to be heated and foamed; wherein, the first patterning blocks of the pattern layer are integrated into the bottom layer during being heated and foamed, so that a semi-finished body is foamily molded; and

Third step: the semi-finished body taken out from the foaming mold, the semi-finished body cut from one peripheral side of the pattern layer to another peripheral side of the pattern layer, wherein one peripheral side of the pattern layer is opposite to another peripheral side of the pattern layer, the semi-finished body separated into two foam mat bodies, wherein the pattern is formed at one side surface of each foam mat body.

Wherein, each second patterning block is located between each two adjacent first patterning blocks; the pattern layer further has a positioning plate; a shape of the positioning plate is the same as a shape of the bottom layer; the positioning plate has a plurality of positioning openings formed thereon; each positioning opening corresponds to each corresponding first patterning block; each first patterning block is inserted into each corresponding positioning opening; the pattern layer further has a positioning plate; a shape of the positioning plate is the same as a shape of the bottom layer; the first patterning blocks are varicolored; the first patterning blocks are grouped into some groups according to the pattern type of the foam mat; the positioning plate has a plurality of positioning openings formed thereon; each positioning opening corresponds to each corresponding group of the first patterning blocks; each group of the first patterning blocks is inserted into each corresponding positioning opening; the forming method of a pattern of a foam mat further comprises:

Fourth step: the foam mat body taken out from the foaming mold, the foam mat body cut into a plurality of foam mat pieces; wherein, a plurality of interlocking teeth is defined at each peripheral side of each foam mat piece.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a flow chart of a first embodiment of the present invention;

FIG. 2 is a side view of a foam mat piece of the first embodiment;

FIG. 3 is a side view of some foam mat pieces which are interlocked;

FIG. 4 is a perspective view of another embodiment of the present invention;

FIG. 5 is a perspective view of a second embodiment of the present invention;

FIG. 6 is a perspective view of a third embodiment of the present invention;

FIG. 7 is a perspective view of a fourth embodiment of the present invention;

FIG. 8 is a perspective view of a fifth embodiment of the present invention;

FIG. 9 is a flow chart of a sixth embodiment of the present invention; and

FIG. 10 is a flow chart of a seventh embodiment of the present invention.

### DETAILED DESCRIPTION OF THE PREFERRED EMBODIMENTS

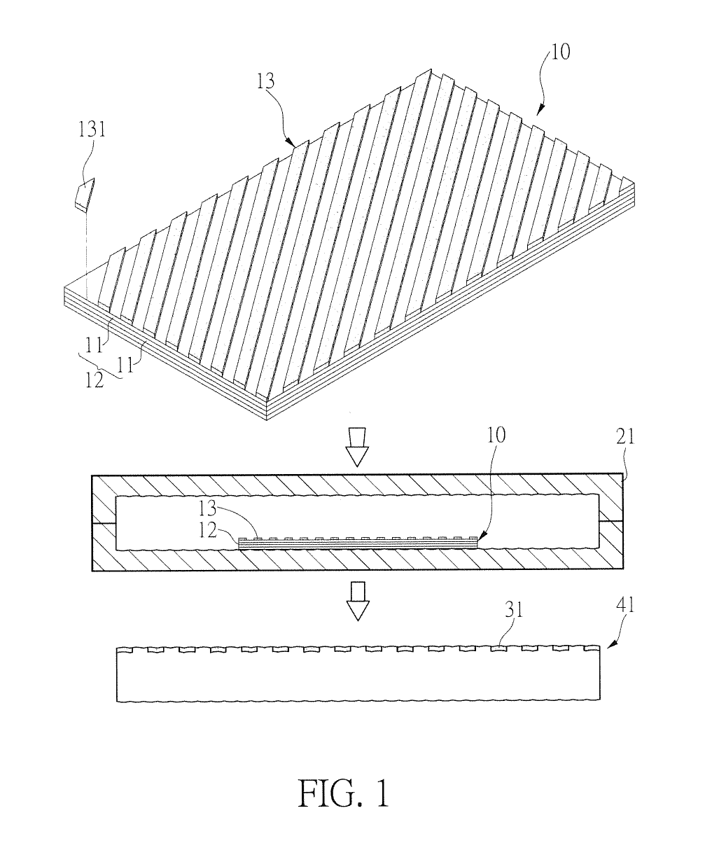

Referring to FIGS. 1-4, a first embodiment of the present invention is described as following. A forming method of a pattern of a foam mat in accordance with the present invention comprises the following steps.

First step: a certain amount of foam plates 11 is stacked up, so as to be defined as a form body 10; wherein, a size of each foam plate 11 is pre-defined; each foam plate 11 is made of a certain foam material (such as PE, EAV . . . etc.) which has been heated and run over and drawn out; the certain amount of foam plates 11 is arranged according to a thickness of the form body 10; the form body 10 has a bottom layer 12 and a pattern layer 13; the pattern layer 13 overlays a top side of the bottom layer 12. Clearly, the pattern layer 13 is composed of a plurality of first patterning blocks 131; a shape of each first patterning block 131 is pre-defined; the first patterning blocks 131 are spaced from each other; a color of each first patterning block 131 is different from a color of the bottom layer 12; each first patterning block 131 is made of a certain foam material (such as PE, EAV . . . etc.) which has been colored with a certain pigment, and heated, and run over and drawn out; each first patterning block 131 is cut as bar-shaped; the first patterning blocks 131 uniformly overlay the top side of the bottom layer 12, according to a pattern type of a foam mat; specially, the first patterning blocks 131 on the bottom layer 12 are parallel with each other and are not parallel with any peripheral side of the form body 10.

Second step: the form body 10 is placed in a foaming mold 21 so as to be heated and foamed; wherein, the first patterning blocks 131 of the pattern layer 13 are integrated into the top side of the bottom layer 12 during being heated and foamed, so that a foam mat body 41 with a pattern 31 is foamily molded.

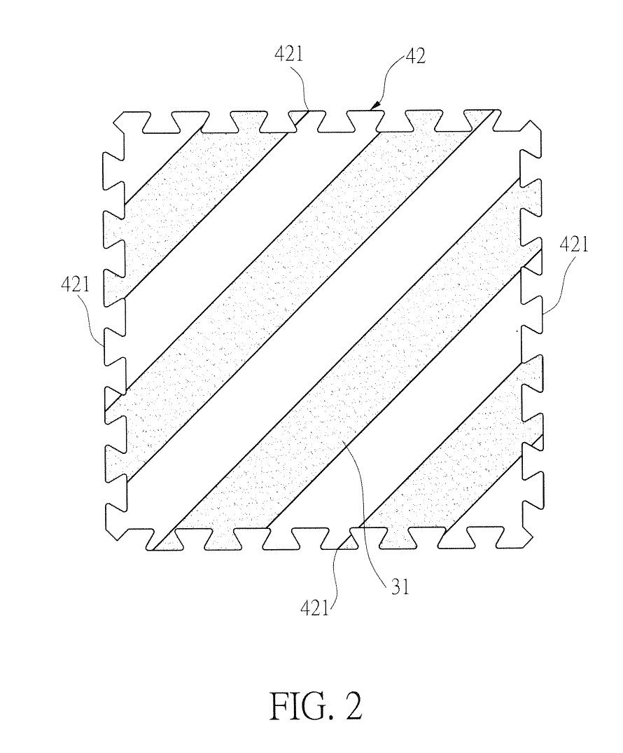

Third step: the foam mat body 41 is taken out from the foaming mold 21; thereafter, the foam mat body 41 is cut into a plurality of foam mat pieces 42; wherein, a plurality of interlocking teeth 421 is defined at each peripheral side of each foam mat piece 42 (as shown in FIG. 2).

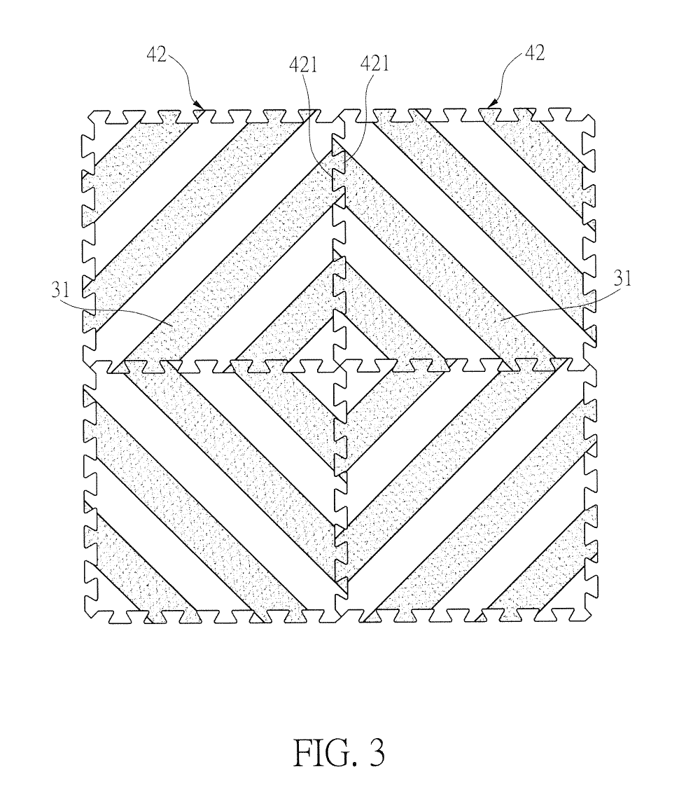

Referring to FIG. 3, one foam mat piece 42 is connected to another foam mat piece 42 via the interlocking teeth 421; in addition, the pattern 31 is variable via said connection.

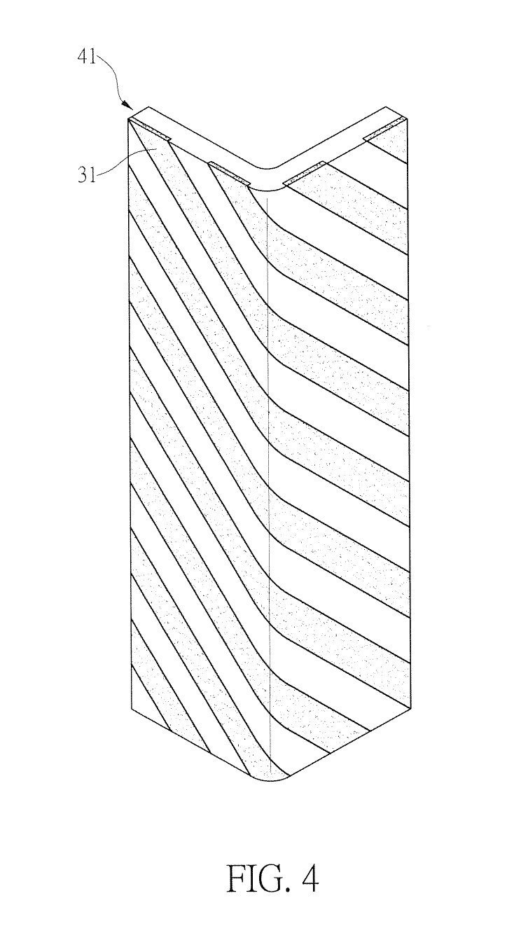

Referring to FIG. 4, the foam mat body 41 is cut and heated and run over, so as to be molded as L-shaped in another embodiment; as a result, the foam mat body 41 can be performed as an anti-collision mat.

Furthermore, the pattern layer 13 further overlays a bottom side of the bottom layer 12 in another embodiment; as a result, the pattern 31 is not only formed at the top side of the bottom layer 12, but also formed at the bottom side of the bottom layer 12; thereafter, the foam mat body 41 is cut from one peripheral side thereof to another peripheral side thereof, wherein one peripheral side of the foam mat body 41 is opposite to another peripheral side of the foam mat body 41; therefore, the foam mat body 41 is separated into two sub foam mat bodies, wherein the pattern 31 is formed at one side surface of each sub foam mat body.

All in all, the advantages of the present invention are shown as following:

First, the present invention just needs only one step (second step) to foam the form body 10 and foamily mold the foam mat body 41 with the pattern 31. Therefore, the forming method of the present invention is simplified; in addition, the pattern 31 would not unexpectedly peel off, because the first patterning blocks 131 are integrated into the form body 10 during being heated and foamed.

Second, a surface of the foam mat body 41 with the pattern 31 is smooth, because the first patterning blocks 131 are integrated into the form body 10 during being heated and foamed. Therefore, the surface of the foam mat body 41 is anti-smudge.

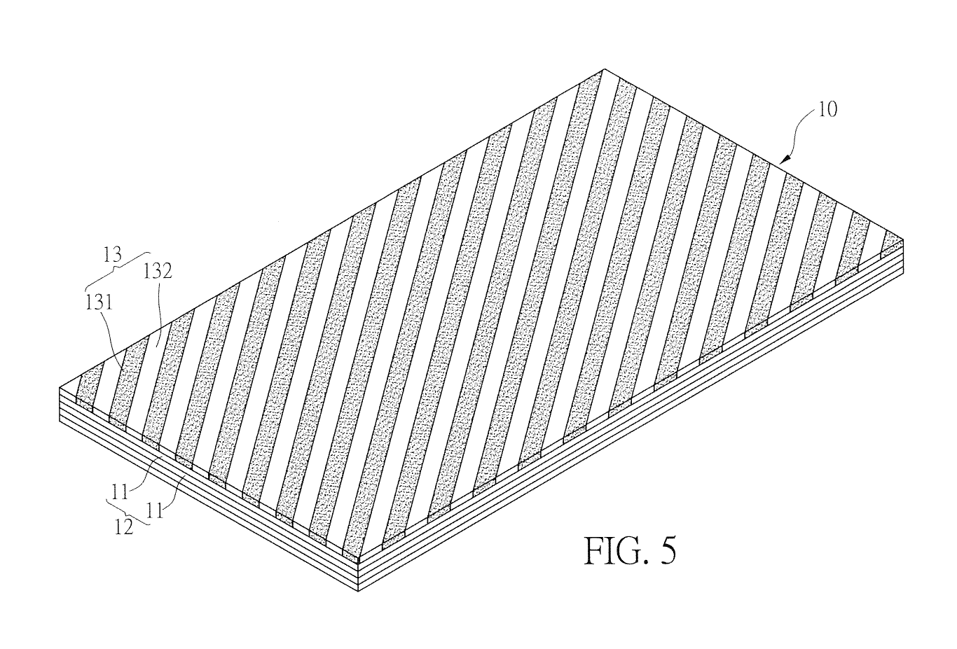

Referring to FIG. 5, a second embodiment of the present invention is described as following (only the differences between the second embodiment and the first embodiment are further described). The pattern layer 13 is composed of a plurality of first patterning blocks 131 and second patterning blocks 132; a shape of each first patterning block 131 is pre-defined; the first patterning blocks 131 are spaced from each other; each second patterning block 132 is located between each two adjacent first patterning blocks 131; each second patterning block 132 is made of a certain foam material (such as PE, EAV . . . etc.); each second patterning block 132 is bar-shaped; a color of each second patterning block 132 is the same as the color of the bottom layer 12; the first patterning blocks 131 and the second patterning blocks 132 uniformly overlay the top side of the bottom layer 12.

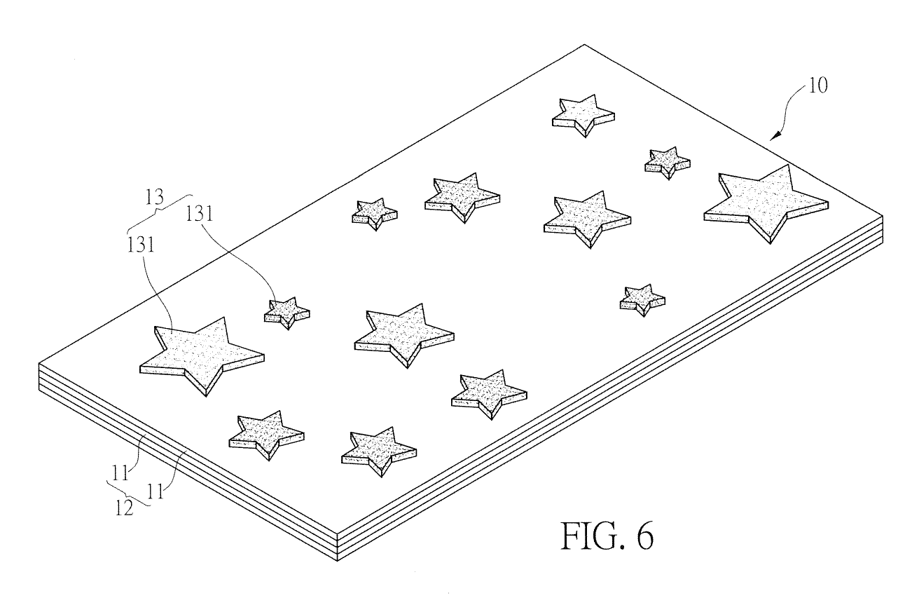

Referring to FIG. 6, a third embodiment of the present invention is described as following (only the differences between the third embodiment and the first embodiment are further described). Each first patterning block 131 is cut as star-shaped; the color of each first patterning block 131 is different from the color of the bottom layer 12; the first patterning blocks 131 uniformly overlay the top side of the bottom layer 12, according to a pattern type of a foam mat.

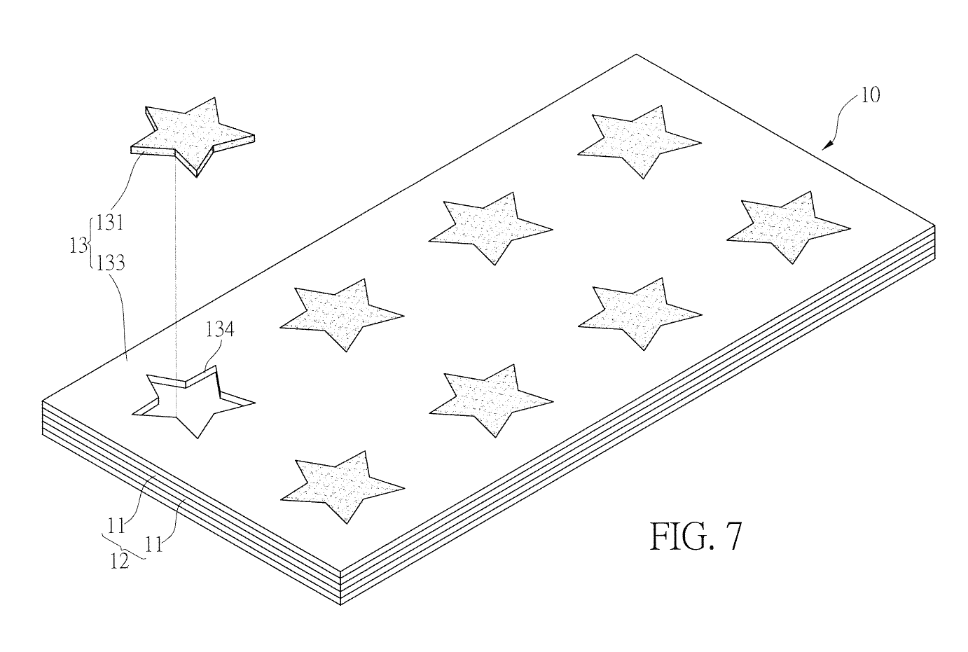

Referring to FIG. 7, a fourth embodiment of the present invention is described as following (only the differences between the fourth embodiment and the first embodiment are further described). The pattern layer 13 is composed of a plurality of first patterning blocks 131 and a positioning plate 133; the positioning plate 133 is made of a certain foam material (such as PE, EAV . . . etc.); a color of the positioning plate 133 is the same as the color of the bottom layer 12; a shape of the positioning plate 133 is the same as a shape of the bottom layer 12; the positioning plate 133 has a plurality of positioning openings 134 formed thereon; each positioning opening 134 corresponds to each corresponding first patterning block 131; each first patterning block 131 is inserted into each corresponding positioning opening 134, so that each first patterning block 131 is positioned at the positioning plate 133 via each corresponding positioning opening 134. Therefore, each first patterning block 131 would not be unexpectedly parted from the positioning plate 133 during forming.

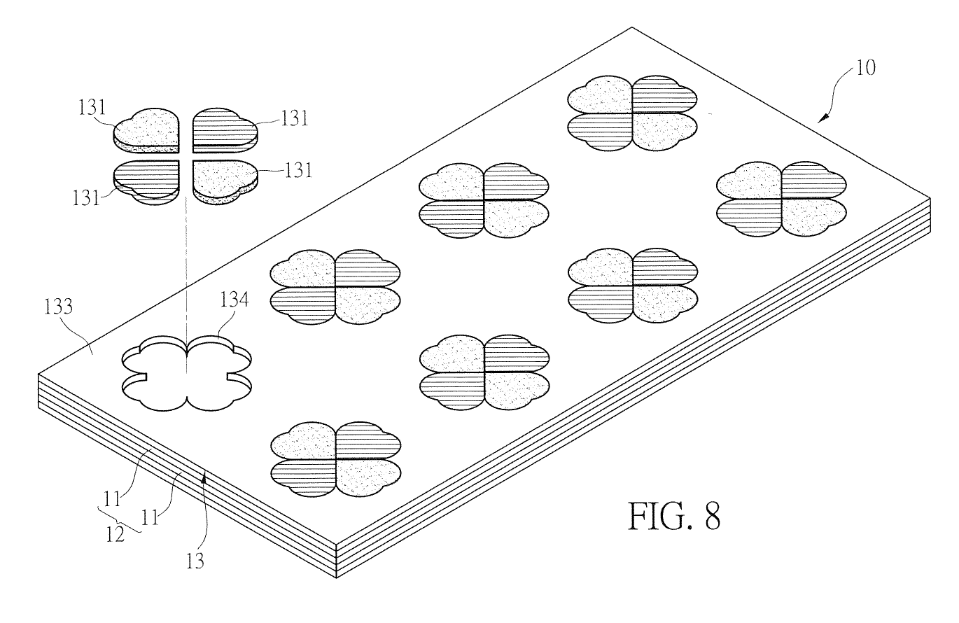

Referring to FIG. 8, a fifth embodiment of the present invention is described as following (only the differences between the fifth embodiment and the first embodiment are further described). The pattern layer 13 is composed of a plurality of first patterning blocks 131 and a positioning plate 133; the positioning plate 133 is made of a certain foam material (such as PE, EAV . . . etc.); a color of the positioning plate 133 is the same as the color of the bottom layer 12; a shape of the positioning plate 133 is the same as a shape of the bottom layer 12; the first patterning blocks 131 are varicolored; the first patterning blocks 131 are grouped into some groups according to the pattern type of the foam mat; the positioning plate 133 has a plurality of positioning openings 134 formed thereon; each positioning opening 134 corresponds to each corresponding group of the first patterning blocks 131; each group of the first patterning blocks 131 is inserted into each corresponding positioning opening 134, so that each group of the first patterning blocks 131 is positioned at the positioning plate 133 via each corresponding positioning opening 134. Therefore, each first patterning block 131 would not be unexpectedly parted from the positioning plate 133 during forming.

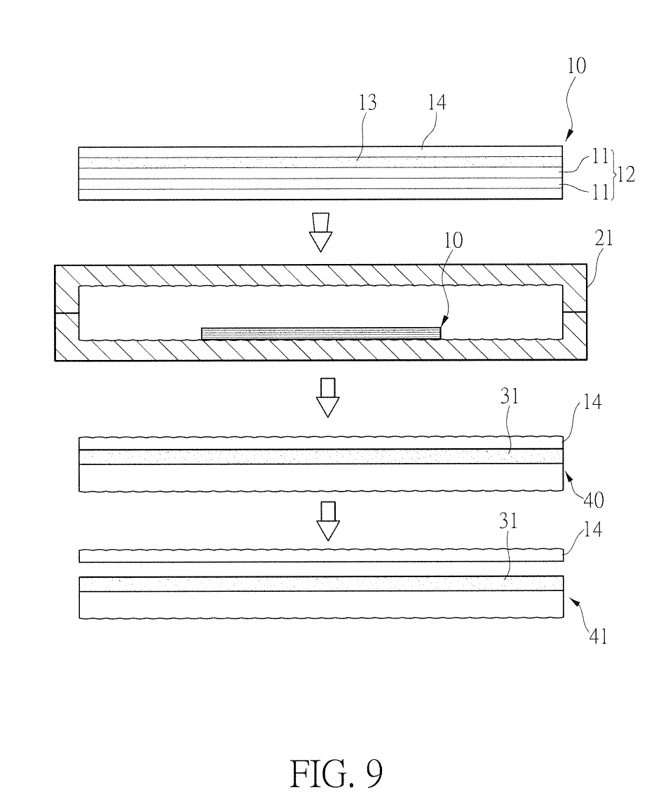

Referring to FIG. 9, a sixth embodiment of the present invention is described as following. A forming method of a pattern of a foam mat in accordance with the present invention comprises the following steps.

First step: a certain amount of foam plates 11 is stacked up, so as to be defined as a form body 10; wherein, a size of each foam plate 11 is pre-defined; each foam plate 11 is made of a certain foam material (such as PE, EAV . . . etc.) which has been heated and run over and drawn out; the certain amount of foam plates 11 is arranged according to a thickness of the form body 10; the form body 10 has a bottom layer 12, a pattern layer 13 and a covering layer 14; the pattern layer 13 overlays a top side of the bottom layer 12; the covering layer 14 overlays a top side of the pattern layer 13. Clearly, the pattern layer 13 is composed of a plurality of first patterning blocks 131 (not shown); a shape of each first patterning block 131 is pre-defined; the first patterning blocks 131 are spaced from each other; a color of each first patterning block 131 is different from a color of the bottom layer 12. Wherein, the pattern layer 13 is performed as FIG. 5, FIG. 7 or FIG. 8. Referring to FIG. 5, the pattern layer 13 is composed of a plurality of first patterning blocks 131 and second patterning blocks 132; a shape of each first patterning block 131 is pre-defined; the first patterning blocks 131 are spaced from each other; each second patterning block 132 is located between each two adjacent first patterning blocks 131; each second patterning block 132 is made of a certain foam material (such as PE, EAV . . . etc.); each second patterning block 132 is bar-shaped; a color of each second patterning block 132 is the same as the color of the bottom layer 12; the first patterning blocks 131 and the second patterning blocks 132 uniformly overlay the top side of the bottom layer 12. Referring to FIG. 7, the pattern layer 13 is composed of a plurality of first patterning blocks 131 and a positioning plate 133; the positioning plate 133 is made of a certain foam material (such as PE, EAV . . . etc.); a color of the positioning plate 133 is the same as the color of the bottom layer 12; a shape of the positioning plate 133 is the same as a shape of the bottom layer 12; the positioning plate 133 has a plurality of positioning openings 134 formed thereon; each positioning opening 134 corresponds to each corresponding first patterning block 131; each first patterning block 131 is inserted into each corresponding positioning opening 134, so that each first patterning block 131 is positioned at the positioning plate 133 via each corresponding positioning opening 134. Referring to FIG. 8, the pattern layer 13 is composed of a plurality of first patterning blocks 131 and a positioning plate 133; the positioning plate 133 is made of a certain foam material (such as PE, EAV . . . etc.); a color of the positioning plate 133 is the same as the color of the bottom layer 12; a shape of the positioning plate 133 is the same as a shape of the bottom layer 12; the first patterning blocks 131 are varicolored; the first patterning blocks 131 are grouped into some groups according to the pattern type of the foam mat; the positioning plate 133 has a plurality of positioning openings 134 formed thereon; each positioning opening 134 corresponds to each corresponding group of the first patterning blocks 131; each group of the first patterning blocks 131 is inserted into each corresponding positioning opening 134, so that each group of the first patterning blocks 131 is positioned at the positioning plate 133 via each corresponding positioning opening 134; therefore, each first patterning block 131 would not be unexpectedly parted from the positioning plate 133 during forming.

Second step: the form body 10 is placed in a foaming mold 21 so as to be heated and foamed; wherein, the first patterning blocks 131 of the pattern layer 13 are integrated into the top side of the bottom layer 12 and a bottom side of the covering layer 14 during being heated and foamed, so that a semi-finished body 40 is foamily molded.

Third step: the semi-finished body 40 is taken out from the foaming mold 21; thereafter, the covering layer 14 is cut from the pattern layer 13, so as to define a foam mat body 41 with a pattern 31.

Fourth step: the foam mat body 41 is cut into a plurality of foam mat pieces 42; wherein, a plurality of interlocking teeth 421 is defined at each peripheral side of each foam mat piece 42.

All in all, the sixth embodiment of the present invention further has an advantage shown as following, besides said advantages of the first embodiment.

The pattern layer 13 is prevented from being rubbed against an inner surface of the foaming mold 21 during being heated and foamed, because the covering layer 14 overlays a top side of the pattern layer 13.

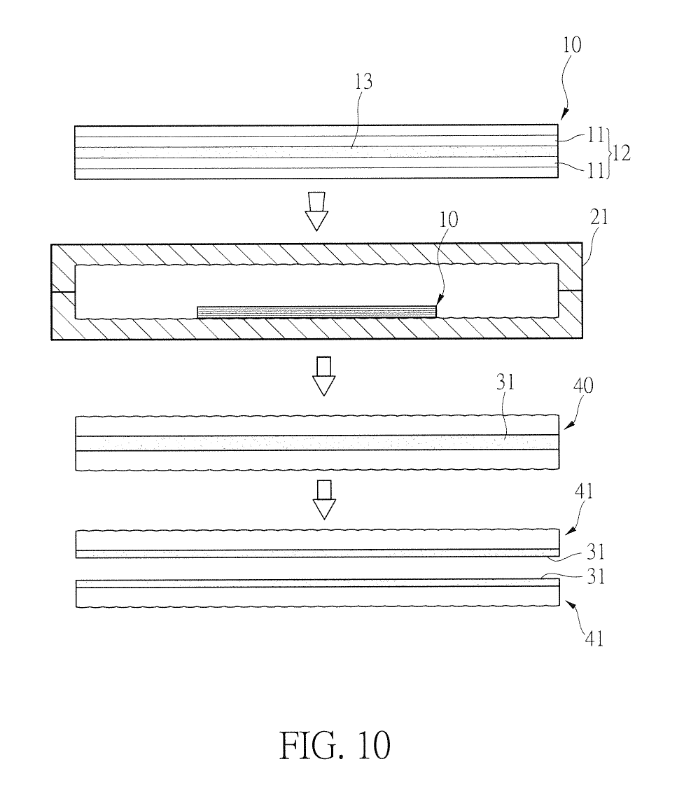

Referring to FIG. 10, a seventh embodiment of the present invention is described as following. A forming method of a pattern of a foam mat in accordance with the present invention comprises the following steps.

First step: a certain amount of foam plates 11 is stacked up, so as to be defined as a form body 10; wherein, a size of each foam plate 11 is pre-defined; each foam plate 11 is made of a certain foam material (such as PE, EAV . . . etc.) which has been heated and run over and drawn out; the certain amount of foam plates 11 is arranged according to a thickness of the form body 10; the form body 10 has a bottom layer 12 and a pattern layer 13; the pattern layer 13 is mounted between two foam plates 11 of the bottom layer 12. Clearly, the pattern layer 13 is composed of a plurality of first patterning blocks 131 (not shown); a shape of each first patterning block 131 is pre-defined; the first patterning blocks 131 are spaced from each other; a color of each first patterning block 131 is different from a color of the bottom layer 12. Wherein, the pattern layer 13 is performed as FIG. 5, FIG. 7 or FIG. 8. Referring to FIG. 5, the pattern layer 13 is composed of a plurality of first patterning blocks 131 and second patterning blocks 132; a shape of each first patterning block 131 is pre-defined; the first patterning blocks 131 are spaced from each other; each second patterning block 132 is located between each two adjacent first patterning blocks 131; each second patterning block 132 is made of a certain foam material (such as PE, EAV . . . etc.); each second patterning block 132 is bar-shaped; a color of each second patterning block 132 is the same as the color of the bottom layer 12; the first patterning blocks 131 and the second patterning blocks 132 uniformly overlay the top side of the bottom layer 12. Referring to FIG. 7, the pattern layer 13 is composed of a plurality of first patterning blocks 131 and a positioning plate 133; the positioning plate 133 is made of a certain foam material (such as PE, EAV . . . etc.); a color of the positioning plate 133 is the same as the color of the bottom layer 12; a shape of the positioning plate 133 is the same as a shape of the bottom layer 12; the positioning plate 133 has a plurality of positioning openings 134 formed thereon; each positioning opening 134 corresponds to each corresponding first patterning block 131; each first patterning block 131 is inserted into each corresponding positioning opening 134, so that each first patterning block 131 is positioned at the positioning plate 133 via each corresponding positioning opening 134. Referring to FIG. 8, the pattern layer 13 is composed of a plurality of first patterning blocks 131 and a positioning plate 133; the positioning plate 133 is made of a certain foam material (such as PE, EAV . . . etc.); a color of the positioning plate 133 is the same as the color of the bottom layer 12; a shape of the positioning plate 133 is the same as a shape of the bottom layer 12; the first patterning blocks 131 are varicolored; the first patterning blocks 131 are grouped into some groups according to the pattern type of the foam mat; the positioning plate 133 has a plurality of positioning openings 134 formed thereon; each positioning opening 134 corresponds to each corresponding group of the first patterning blocks 131; each group of the first patterning blocks 131 is inserted into each corresponding positioning opening 134, so that each group of the first patterning blocks 131 is positioned at the positioning plate 133 via each corresponding positioning opening 134; therefore, each first patterning block 131 would not be unexpectedly parted from the positioning plate 133 during forming.

Second step: the form body 10 is placed in a foaming mold 21 so as to be heated and foamed; wherein, the first patterning blocks 131 of the pattern layer 13 are integrated into a top side of one foam plate 11 of the bottom layer 12 and a bottom side of another foam plate 11 of the bottom layer 12 during being heated and foamed, so that a semi-finished body 40 is foamily molded.

Third step: the semi-finished body 40 is taken out from the foaming mold 21; thereafter, the semi-finished body 40 is cut from one peripheral side of the pattern layer 13 to another peripheral side of the pattern layer 13, wherein one peripheral side of the pattern layer 13 is opposite to another peripheral side of the pattern layer 13; therefore, the semi-finished body 40 is separated into two foam mat bodies 41, wherein the pattern 31 is formed at one side surface of each foam mat body 41.

Fourth step: the foam mat body 41 is cut into a plurality of foam mat pieces 42; wherein, a plurality of interlocking teeth 421 is defined at each peripheral side of each foam mat piece 42.

All in all, the seventh embodiment of the present invention further has an advantage shown as following, besides said advantages of the first embodiment.

The pattern layer 13 is prevented from being rubbed against an inner surface of the foaming mold 21 during being heated and foamed, because the pattern layer 13 is mounted between two foam plates 11 of the bottom layer 12.

Although particular embodiments of the invention have been described in detail for purposes of illustration, various modifications and enhancements may be made without departing from the spirit and scope of the invention. Accordingly, the invention is not to be limited except as by the appended claims.

1. A forming method of a pattern of a foam mat comprising:
First step: a certain amount of foam plates being stacked up, so as to be defined as a form body, the form body having a bottom layer and a pattern layer, the bottom layer composed of some foam plates, the pattern layer overlaying a top side of the bottom layer, the pattern layer composed of a plurality of first patterning blocks, a shape of each first patterning block being pre-defined; a color of each first patterning block being different from a color of the bottom layer; and
Second step: the form body placed in a foaming mold so as to be heated and foamed; wherein, the first patterning blocks of the pattern layer integrated into the top side of the bottom layer during being heated and foamed, so that a foam mat body with a pattern is foamily molded.

2. The forming method of a pattern of a foam mat as claimed in claim wherein each second patterning block is located between each two adjacent first patterning blocks.

3. The forming method of a pattern of a foam mat as claimed in claim 1, wherein the pattern layer further has a positioning plate; a shape of the positioning plate is the same as a shape of the bottom layer; the positioning plate has a plurality of positioning openings formed thereon; each positioning opening corresponds to each corresponding first patterning block; each first patterning block is inserted into each corresponding positioning opening.

4. The forming method of a pattern of a foam mat as claimed in claim 1, wherein the pattern layer further has a positioning plate; a shape of the positioning plate is the same as a shape of the bottom layer; the first patterning blocks are varicolored; the first patterning blocks are grouped into some groups according to the pattern type of the foam mat; the positioning plate has a plurality of positioning openings formed thereon; each positioning opening corresponds to each corresponding group of the first patterning blocks; each group of the first patterning blocks is inserted into each corresponding positioning opening.

5. The forming method of a pattern of a foam mat as claimed in claim 1 further comprising:
Third step: the foam mat body taken out from the foaming mold, the foam mat body cut into a plurality of foam mat pieces; wherein, a plurality of interlocking teeth is defined at each peripheral side of each foam mat piece.

6. A forming method of a pattern of a foam mat comprising:
First step: a certain amount of foam plates being stacked up, so as to be defined as a form body, the form body having a bottom layer, a pattern layer and a covering layer, the bottom layer composed of some foam plates, the pattern layer overlaying a top side of the bottom layer, the covering layer overlaying a top side of the pattern layer, the pattern layer composed of a plurality of first patterning blocks; a shape of each first patterning block being pre-defined, a color of each first patterning block being different from a color of the bottom layer;
Second step: the form body placed in a foaming mold so as to be heated and foamed; wherein, the first patterning blocks of the pattern layer are integrated into the bottom layer and the covering layer during being heated and foamed, so that a semi-finished body is foamily molded; and
Third step: the semi-finished body taken out from the foaming mold, the covering layer cut from the pattern layer, so as to define a foam mat body with a pattern.

7. The forming method of a pattern of a foam mat as claimed in claim 6, wherein each second patterning block is located between each two adjacent first patterning blocks.

8. The forming method of a pattern of a foam mat as claimed in claim 6, wherein the pattern layer further has a positioning plate; a shape of the positioning plate is the same as a shape of the bottom layer; the positioning plate has a plurality of positioning openings formed thereon; each positioning opening corresponds to each corresponding first patterning block; each first patterning block is inserted into each corresponding positioning opening.

9. The forming method of a pattern of a foam mat as claimed in claim 6, wherein the pattern layer further has a positioning plate; a shape of the positioning plate is the same as a shape of the bottom layer; the first patterning blocks are varicolored; the first patterning blocks are grouped into some groups according to the pattern type of the foam mat; the positioning plate has a plurality of positioning openings formed thereon; each positioning opening corresponds to each corresponding group of the first patterning blocks; each group of the first patterning blocks is inserted into each corresponding positioning opening.

10. The forming method of a pattern of a foam mat as claimed in claim 6 further comprising:
Fourth step: the foam mat body taken out from the foaming mold, the foam mat body cut into a plurality of foam mat pieces; wherein, a plurality of interlocking teeth is defined at each peripheral side of each foam mat piece.

11. A forming method of a pattern of a foam mat comprising:
First step: a certain amount of foam plates being stacked up, so as to be defined as a form body, the form body having a bottom layer and a pattern layer, the bottom layer composed of some foam plates, the pattern layer mounted between two foam plates of the bottom layer, the pattern layer composed of a plurality of first patterning blocks, a shape of each first patterning block being pre-defined, a color of each first patterning block being different from a color of the bottom layer;
Second step: the form body placed in a foaming mold so as to be heated and foamed; wherein, the first patterning blocks of the pattern layer are integrated into the bottom layer during being heated and foamed, so that a semi-finished body is foamily molded; and
Third step: the semi-finished body taken out from the foaming mold, the semi-finished body cut from one peripheral side of the pattern layer to another peripheral side of the pattern layer, wherein one peripheral side of the pattern layer is opposite to another peripheral side of the pattern layer, the semi-finished body separated into two foam mat bodies, wherein the pattern is formed at one side surface of each foam mat body.

12. The forming method of a pattern of a foam mat as claimed in claim 11, wherein each second patterning block is located between each two adjacent first patterning blocks.

13. The forming method of a pattern of a foam mat as claimed in claim 11, wherein the pattern layer further has a positioning plate; a shape of the positioning plate is the same as a shape of the bottom layer; the positioning plate has a plurality of positioning openings formed thereon; each positioning opening corresponds to each corresponding first patterning block; each first patterning block is inserted into each corresponding positioning opening.

14. The forming method of a pattern of a foam mat as claimed in claim 11, wherein the pattern layer further has a positioning plate; a shape of the positioning plate is the same as a shape of the bottom layer; the first patterning blocks are varicolored; the first patterning blocks are grouped into some groups according to the pattern type of the foam mat; the positioning plate has a plurality of positioning openings formed thereon; each positioning opening corresponds to each corresponding group of the first patterning blocks; each group of the first patterning blocks is inserted into each corresponding positioning opening.

15. The forming method of a pattern of a foam mat as claimed in claim 11 further comprising:
Fourth step: the foam mat body taken out from the foaming mold, the foam mat body cut into a plurality of foam mat pieces; wherein, a plurality of interlocking teeth is defined at each peripheral side of each foam mat piece.
